(19) United States
(12) Patent Application Publication
(10) Pub. No.: US 2021/0302015 A1
(43) Pub. Date: Sep. 30, 2021

(54) Lasting And Representative Dim Light Apparatus

(71) Applicant: Samir Moufawad Moufawad, Mazraat Yashouh (LB)

(72) Inventor: Samir Moufawad Moufawad, Mazraat Yashouh (LB)

(21) Appl. No.: 16/827,715

(22) Filed: Mar. 24, 2020

(51) Int. Cl. F21V 33/00; F21L 4/02

(52) U.S. Cl. CPC F21V 33/0032; F21Y 2115/10; F21L 4/027

(57) ABSTRACT

Lasting and representative dim light apparatus comprises mainly electric storage components and LEDs emitting dim light illuminating an image or a shape. The dim light can stay on for years and even for tens of years. Although dim light can illuminate only very close objects, the main purpose of the invention is to have the illuminated image or shape represent or is associated to something tangible or intangible, someone or spiritual someone. Since the dim light will stay on for years and tens of years, it can represent or be associated to love, religion and religious figures, icons, logos, free energy, breaking the darkness, removing fear of darkness, peace, eternity, big bang, stars, moons, galaxies, symbols, characters, believes, feelings, magic, myths, concepts, stories, honoring, faith, themes, proverbs, promotions, or advertisements.

### BACKGROUND OF THE INVENTION

### Field of the Invention

Embodiments of the invention described herein pertain to the field of lights. More particularly, but not by way of limitation, one or more embodiments of the invention enables a lasting and representative dim light apparatus.

### Description of the Related Art

LEDs took over the lighting industry mainly because they are very efficient in producing light vs. heat. Nevertheless, it is advantageous to know that LEDs generate visible light with currents not only in amperes or milliamps, but also in microamperes and even in a fraction of a microampere. The advantage of a dim light is that its power source can last a long time. But such dim or very dim light can illuminate only very close objects. It doesn't seem that there are devices with dim light which last for years and even for tens of years. One device seen is a flashlight with an LED powered with 1 milliamp and lasts for 3 months. Yet, this device is used for viewing purpose. Other utilizations of LEDs are as indicators such as power on/off, a function on/off, or for indicating different numbers. Powering of these LED indicators can go as low as few tenth of a milliamp/hour.

### BRIEF SUMMARY OF THE INVENTION

The focus in the market is the intensity of an LED light. It seems that an LED generating dim light not suitable for lighting has no use. It is indeed difficult to use dim light to illuminate our surrounding in order for us to see. The present invention makes use of such dim light since the dimmer the light the longer its power source will last. Dim and very dim lights can emit light for years and even for tens of years, when used with ordinary batteries, lithium batteries, or rechargeable batteries or super capacitors recharged by solar cells.

With the present invention, we will focus on how dim an LED can be which implies how long can the light stays on, and how can we make use of this dim or very dim light? We make use of a dim light by giving it a meaning: have it light a shape, an image, or written words which represent or is associated to something tangible or intangible, or someone or spiritual someone.

The dim light can last for years even with ordinary batteries. For example: four new AA alkaline batteries supplying a current of 50 microamperes can last for more than 5 years. Four new AA lithium batteries supplying a current of 40 microamperes can last about ten years.

A dim light which lasts for years and even for tens of years is useful when it represents something of someone. For example: placing a dim light lasting for years, in a candle flame shape would be used for romance or love. In front of a photo of loved ones or a religious figure represents honoring.

Devices which provide long lasting light can also be associated with many things. For example, long lasting dim LED can represent the Big Bang, the myth of free energy, stars, the moon, galaxies, breaking the darkness, or removing the fear of darkness. Long lasting dim light illuminating a star shape can mean the light of a star which lives for billions of years. Long lasting dim light illuminating a heart represents love. Long lasting dim blinking light illuminating a heart represents heartbeats. Long lasting dim light illuminating a wand gives the impression of real magic. Long lasting dim light illuminating an olive leave represents peace. Long lasting dim light illuminating a star could mean Christmas star. Other meanings, associations or representations include religion and religious figures, icons, logos, symbols, characters, feelings, concepts, stories, faith, themes, proverbs, promotions, advertisements, decoration, honoring, symbolizing, belief, faith, or luck.

Even though dim light can illuminate very close objects, the main purpose of the present invention is not about lighting to be able to see. The main purpose is not as indicators. Dim light lasting a very long time gives the impression of eternity or eternal things.

### BRIEF DESCRIPTION OF THE DRAWINGS

The above and other aspects, features and advantages of the invention will be more apparent from the following more particular description thereof, presented in conjunction with the following drawings wherein:

FIG. 1 is a diagram of an exemplary embodiment of an LED emitting dim light in a heart shape of a picture frame holder in accordance with the lasting and representative dim light apparatus described herein.

FIG. 2 illustrates an exemplary embodiment of 2 LEDs emitting dim light in a flame shape of a candlestick in accordance with the lasting and representative dim light apparatus described herein.

FIG. 3 is a diagram of an exemplary electronic circuit with a battery set powering an LED in accordance with the lasting and representative dim light apparatus described herein.

FIG. 4 illustrates an exemplary embodiment of an LED emitting dim light in a star shape in accordance with the lasting and representative dim light apparatus described herein.

FIG. 5 is diagram of an exemplary electronic circuit with many battery sets powering many LEDs in accordance with the lasting and representative dim light apparatus described herein.

FIG. 6 is a diagram of an exemplary blinking electronic circuit powering LEDs in accordance with the lasting and representative dim light apparatus described herein.

FIG. 7 is a diagram of an exemplary electronic circuit with many battery sets and many solar cells powering an LED in accordance with the lasting and representative dim light apparatus described herein.

FIG. 8 is a diagram of an exemplary electronic circuit with many solar cells powering rechargeable electrical energy storage components in accordance with the lasting and representative dim light apparatus described herein.

FIG. 9 illustrates an exemplary embodiment of an LED emitting dim light through a transparent religious icon in accordance with the lasting and representative dim light apparatus described herein.

FIG. 10 illustrates an exemplary embodiment of solar cells powering an LED emitting dim light through a transparent flag image in accordance with the lasting and representative dim light apparatus described herein.

FIG. 11 illustrates an exemplary embodiment of batteries placed on three dimensional axes powering LEDs placed at the origin and emitting dim light in accordance with the lasting and representative dim light apparatus described herein.

FIG. 12 illustrates an exemplary embodiment of wand comprising batteries and an LED emitting dim light in accordance with the lasting and representative dim light apparatus described herein.

FIG. 13 illustrates an exemplary pyramid shape embodiment comprising solar cells, batteries, capacitors and an LED emitting dim light in accordance with the lasting and representative dim light apparatus described herein.

FIG. 14 illustrates an exemplary various transparent images or shapes representing something or someone in accordance with the lasting and representative dim light apparatus described herein.

### DETAILED DESCRIPTION

The lasting and representative dim light apparatus will now be described using exemplary embodiments of the invention. It will be apparent to an ordinary skilled in the art person that the present invention may be practiced without incorporating all its aspects herein. Readers should note that although examples of the invention are set forth herein, the claims, and the full scope of any equivalents, are what define the metes and bounds of the inventions.

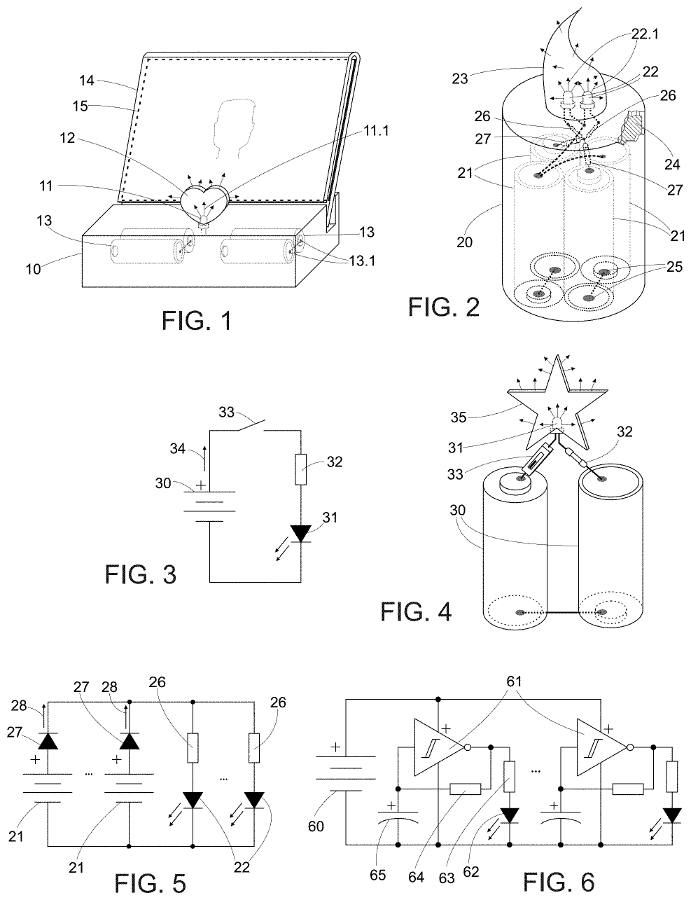

FIG. 1 is a diagram of an exemplary embodiment of an LED emitting dim light in a heart shape of a picture frame holder in accordance with the lasting and representative dim light apparatus described herein.

Picture frame holder 10 comprises an LED 11 emitting dim light 11.1 illuminating a heart shape 12, batteries 13 which provide power to LED 11, and electronic components. Picture frame holder 10 can hold a picture frame 14 which holds a replaceable picture, photo, or image 15. All the wirings are preferably soldered 13.1 to ensure proper contact for years. As we shall see later by calculation that LED 11 will stay on emitting dim light for years and even for more than ten years. A heart lit for years offers new meaning and new representation of eternal love. Picture frame 14 can also hold a picture of a text representing a theme, a proverb, a story or a concept.

FIG. 2 illustrates an exemplary embodiment of 2 LEDs emitting dim light in a flame shape of a candlestick in accordance with the lasting and representative dim light apparatus described herein.

Candlestick 20 comprises 2 LEDs 22 emitting dim light 22.1 illuminating flame shape 23. One or both LEDs 22 can be blinking to simulate a real candle flame. Candlestick 20 also has two sets of two batteries 21. One set of batteries is made of one battery with 3 volts or more, or the connection in series of two or more 1.5 volt batteries. LEDs 22 are powered through resistors 26, and diodes 27. All the wirings are preferably soldered 25 to ensure proper contact for years. At least batteries 21 are preferably enclosed in sealant 24 to prevent leaking. There exist candlesticks which use LEDs and batteries, however, the light is not dim and therefore batteries can only last a short time which is no longer than few months and afterwards need to be replaced. As we shall see later by calculation that the candlestick light of the present invention will stay on for years and even for more than ten years. A lit flame shape for years offers new meaning and new representation of romance, love, or eternal honoring.

FIG. 3 is a diagram of an exemplary electronic circuit with a battery set powering an LED in accordance with the lasting and representative dim light apparatus described herein.

The simple circuit of FIG. 3 is composed of batteries 30, LED 31, resistor 32 which can also be a transistor used as resistor, and a switch 33. FIG. 4 is an embodiment of the electronic circuit of FIG.3 with LED 31 illuminating star shape 35. From Ohm's law the value of resistor 32 equals to the voltage across batteries 30 minus the voltage across LED 31 divided by current 34. For example at about 2.7 volts, a white or warm white LED consumes about 50 microamperes. Using two 1.5 v batteries connected in series will give resistor 32 value of (3−2.7)/0.00005 or 6k Ohms. Considering two new AA Alkaline batteries connected in series, they will produce 3 volts, have a capacity of 3 amperes/hour, and a shelf life of 10 years. Since the shelf life is 10 years, this means that the approximated average internal current loss is 3 amperes divided by 10 years divided by 24 hours divided by 365 days which is equal to 34 microamperes/hour.

If the two AA Alkaline batteries provide 50 milliamps/hour then they will last 3/(0.05+0.000034) or about 60 hours.

If the two AA Alkaline batteries provide 50 microamperes/hour then they will last 3/(0.00005+0.000034) or about 35714 hours or about 4 years. Providing a current of 9 microamperes/hour, the batteries will last about 8 years.

If two C Alkaline batteries provide 50 microamperes/hour then they will last 8/(0.00005+0.000091) or about 56607 hours or about 6.5 years.

If two lithium AA batteries with life shelf of 20 years, provide 50 microamperes/hour then they will last 3.3/(0.00005+0.000019) or about 47940 hours or about 5.5 years. Providing a current of 6 microamperes/hour, the batteries will last about 15 years.

It is the purpose of the present invention to use this lasting light. It is noted that LEDs can emit light for even a fraction of a microampere, but it is not comfortable to see such very dim light. However, it becomes comfortable to see when many LEDs are emitting very dim light at the same time. LED light starting from around 20 microamperes is comfortable and at 50 microamperes is well comfortable to see and be used to see very close objects.

Switch 33 is used to turn on/off LED 31. However, it is not needed much since the light stays on for years. But, it can used to save batteries especially when the long lasting light apparatus is in storage. If switch 33 is not used, then it is easier to dip all components in sealant such as resin, epoxy, or silicon to protect the components from battery leakage or corrosion of wires and contacts.

FIG. 5 is diagram of an exemplary electronic circuit with many battery sets powering many LEDs in accordance with the lasting and representative dim light apparatus described herein.

The embodiment of the electronic circuit of FIG. 5 is shown as the candlestick of FIG. 2. Batteries can be connected in parallel, but if one dies and becomes short circuited, it will drain other batteries. To be able to better use more than one set of batteries, diodes 27 are connected in series with batteries 21. The forward connection of diodes 27 enables current 28 to flow. Thus, the role of diodes 27 is to protect other batteries from getting shorted. More LEDs 22 can be used and they are coupled through resistances 26 in parallel to batteries 21 with their diodes 27.

FIG. 6 is a diagram of an exemplary blinking electronic circuit powering LEDs in accordance with the lasting and representative dim light apparatus described herein.

Schmitt trigger inverters 61 can be used to blink LEDs 62 which will simulate heart beat as in picture frame of FIG. 1 or candle flame as in candlestick of FIG. 2. The speed of the blinking is determined by the equation frequency=k/(capacitance 65×resistance 64), where k is the Schmitt trigger constant. Schmitt trigger inverters 61 consume few microamperes/hour. However, since LEDs 62 are blinking which means that they will be off for some time during their duty cycle, the result will be a longer lasting time for batteries 60.

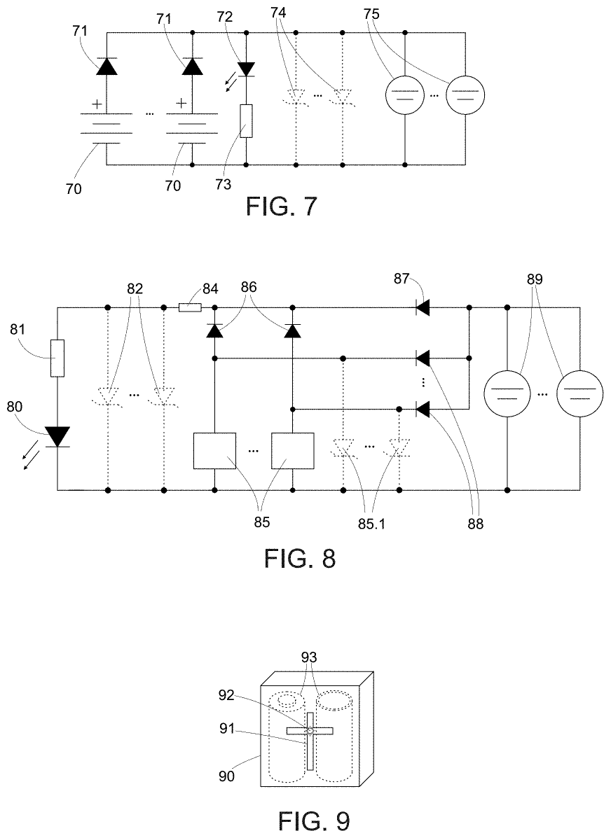

FIG. 7 is diagram of an exemplary electronic circuit with many battery sets and many solar cells powering an LED in accordance with the lasting and representative dim light apparatus described herein.

Solar cells 75 can be added as shown in FIG. 7, to provide power to LED 72. To do so, the voltage of solar cells 75 is made higher than the voltage provided by batteries 70 through diodes 71, thus saving the energy of batteries 70. In this case diodes 71 will block the reverse current and protect the non-rechargeable batteries 70. Therefore, during the day when there is sun light, solar cells 75 will produce energy to power LED 72, and during the night batteries 70 will power LED 72. Solar cells 75 will produce energy even when placed indoor. The energy produces indoor provides current in microamperes which is suitable to power LED 72. If solar cells 75 are placed in full sunlight, then zener diodes 74 can be used to limit the current flow through LED 72 thus maintaining a constant light intensity.

FIG. 8 is a diagram of an exemplary electronic circuit with many solar cells powering rechargeable electrical energy storage components in accordance with the lasting and representative dim light apparatus described herein.

Increasing the number of solar cells 89, enables the generation of more energy needed to power LED 80. Thus, the excess energy can be stored in electrical energy storage components 85 such as rechargeable batteries and capacitors preferably super capacitors which hold a lot more charge than regular capacitors. The stored energy is used during the night or where there is no or little light hitting solar cells 89. The optional presence of zener diodes 82 is to ensure constant light intensity from LED 80. The presence of diodes 86 is to power LED 80 from energy storage 85, when solar cells 89 are not generating energy. Diode 87 is used to power LED 80 without going through energy storages 85. Diodes 88 are used to charge energy storage 85 from solar cells 89. Zener diodes 85.1 are used to protect energy storage 85 from overvoltage.

FIG. 9 illustrates an exemplary embodiment of an LED emitting dim light through a transparent religious icon in accordance with the lasting and representative dim light apparatus described herein.

FIG. 9 shows a small embodiment 90 including one or two small size batteries 93 powering LED 92 illuminating religious icon 91. Other icons, logos, symbols, characters can be used for honoring, advertisement, promotion, faith, believe, or as toys or gadgets including star, heart, moon, or car shapes or images. A gadget illuminating a text can represent a theme, a proverb, a story, or a concept. A gadget illuminating a star can break the darkness or help removing the fear of darkness. Using 2 new 1.5 v AAAA batteries each with capacity 670 milliamps and life shelf 5 years, an LED consuming 20 microamperes/hour or 5 microamperes/hour will stay on for about 2.2 and 3.8 years respectively. Using one new 3 v lithium battery EL123AP with capacity 1500 milliamps and life shelf 10 years, an LED consuming 20 microamperes/hour or 5 microamperes/hour will stay on for about 4.6 and 7.7 years respectively. Embodiment 90 is preferred to be filled with sealant, or itself made from resin to prevent leakage, for water proofing, and for maintenance free.

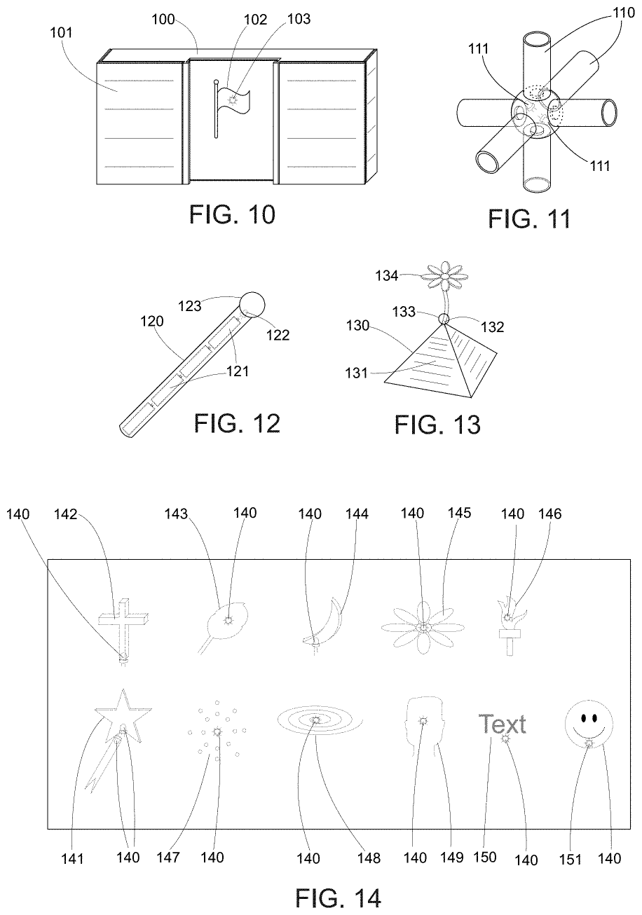

FIG. 10 illustrates an exemplary embodiment of solar cells powering an LED emitting dim light through a transparent flag image in accordance with the lasting and representative dim light apparatus described herein.

LED 103 in embodiment 100 can stay on for more than 20 years. LED 103 illuminates replaceable transparent flag image 102, and can be powered by any combination of components described before. The length of time LED 103 will stay on is determined by the life of the components used. For example solar cells 101 and capacitors have a life time of more than 20 years, therefore LED 103 can stay on for more than 20 years.

FIG. 11 illustrates an exemplary embodiment of batteries placed on three dimensional axes powering LEDs placed at the origin and emitting dim light in accordance with the lasting and representative dim light apparatus described herein.

In this embodiment, batteries 110 are placed in the x-y-z axes and LEDs 111 are placed at the origin. This may give the impression of free energy or the big bang. Using 6 new AA lithium batteries with a capacity each 3300 milliamps and a life shelf to 20 years, 2 LEDs consuming 50 microamperes/hour or 20 microamperes/hour will stay on for about 10.6 and 14.8 years respectively.

FIG. 12 illustrates an exemplary embodiment of wand comprising batteries and an LED emitting dim light in accordance with the lasting and representative dim light apparatus described herein.

In this embodiment, wand 120 includes batteries 121, LED 122 inside a spherical shape 123. LED 122 staying on for a long time gives the impression of real magic.

FIG. 13 illustrates an exemplary pyramid shape embodiment comprising solar cells, batteries, capacitors and an LED emitting dim light in accordance with the lasting and representative dim light apparatus described herein.

In this embodiment, pyramid 130 includes batteries, capacitors, solar cells 131, and LED 132 inside a spherical shape 133. LED 132 staying on for years gives the impression of eternal light or eternity, or old civilization. A shape of a flower 134 can be used for decoration. The time LED 103 will stay on is determined by the life of the components used and can be more than twenty years.

FIG. 14 illustrates an exemplary various transparent images or shapes representing something or someone in accordance with the lasting and representative dim light apparatus described herein.

The various images or shapes illuminated by LEDs 140 represent various things, or persons. Star 141 can represent Christmas Star. Iconic shape 142 represents a religion. Leave 143 can represent peace. Shape 144 represents the moon. Flower image 145 can be lit for decoration. The torch image 146 can represent freedom. Some circle collection 147 can represent dark energy or the big bang. Image 148 can represent a galaxy. Face image 149 can represent someone or spiritual someone. Text 150 can represent believes, concepts, stories, faith, themes, or proverbs. Smiley face 151 represents feelings.

1. Lasting and representative dim light apparatus comprising:
at least one LED;
at least one of a battery, a rechargeable battery, a capacitor, or a solar cell; and
at least one of an image, a photo, a picture, a transparent image, a transparent photo, a transparent picture, a shape, a transparent shape, a written word, a transparent written word, a written text, or a transparent written text,
wherein light emitted by said at least one LED ranges from dim to very dim,
wherein said at least one of an image, a photo, a picture, a transparent image, a transparent photo, a transparent picture, a shape, a transparent shape, a written word, a transparent written word, a written text, or a transparent written text, represents or is associated to something tangible or intangible, someone, or spiritual someone,
wherein said something tangible or intangible, or someone or spiritual someone includes religion, religious figures, love, icons, logos, free energy, breaking the darkness, removing fear of darkness, peace, eternity, big bang, stars, moons, galaxies, symbols, characters, believes, feelings, magic, myths, concepts, stories, honoring, faith, themes, proverbs, promotions, or advertisements.

2. The lasting and representative dim light apparatus of claim 1 further including at least one of a switch, a blinking circuit, or a zener diode.

3. The lasting and representative dim light apparatus of claim 1 wherein at least one contact is soldered.

4. The lasting and representative dim light apparatus of claim 2 wherein at least one contact is soldered.

5. The lasting and representative dim light apparatus of claim 1 wherein said lasting and representative dim light apparatus or said at least one of a battery, a rechargeable battery, or a capacitor, is leakage or water proof, or leakage and water proof.

6. The lasting and representative dim light apparatus of claim 2 wherein said lasting and representative dim light apparatus or said at least one of a battery, a rechargeable battery, or a capacitor, is leakage or water proof, or leakage and water proof.

7. The lasting and representative dim light apparatus of claim 3 wherein said lasting and representative dim light apparatus or said at least one of a battery, a rechargeable battery, or a capacitor, is leakage or water proof, or leakage and water proof.

8. The lasting and representative dim light apparatus of claim 4 wherein said lasting and representative dim light apparatus or said at least one of a battery, a rechargeable battery, or a capacitor, is leakage or water proof, or leakage and water proof.

9. The lasting and representative dim light apparatus of claim 1 wherein said at least one of an image, a photo, a picture, a transparent image, a transparent photo, or a transparent picture, is replaceable.

10. The lasting and representative dim light apparatus of claim 1 illuminates close or very close objects.

11. The lasting and representative dim light apparatus of claim 2 wherein said at least one of an image, a photo, a picture, a transparent image, a transparent photo, or a transparent picture, is replaceable.

12. The lasting and representative dim light apparatus of claim 3 wherein said at least one of an image, a photo, a picture, a transparent image, a transparent photo, or a transparent picture, is replaceable.

13. The lasting and representative dim light apparatus of claim 4 wherein said at least one of an image, a photo, a picture, a transparent image, a transparent photo, or a transparent picture, is replaceable.

14. The lasting and representative dim light apparatus of claim 5 wherein said at least one of an image, a photo, a picture, a transparent image, a transparent photo, or a transparent picture, is replaceable.

15. The lasting and representative dim light apparatus of claim 6 wherein said at least one of an image, a photo, a picture, a transparent image, a transparent photo, or a transparent picture, is replaceable.

16. The lasting and representative dim light apparatus of claim 7 wherein said at least one of an image, a photo, a picture, a transparent image, a transparent photo, or a transparent picture, is replaceable.

17. The lasting and representative dim light apparatus of claim 8 wherein said at least one of an image, a photo, a picture, a transparent image, a transparent photo, or a transparent picture, is replaceable.

18. The lasting and representative dim light apparatus of claim 2 illuminates close or very close objects.

19. The lasting and representative dim light apparatus of claim 5 illuminates close or very close objects.

20. The lasting and representative dim light apparatus of claim 6 illuminates close or very close objects.
